(19) United States
(12) Patent Application Publication
(10) Pub. No.: US 2005/0180740 A1
(43) Pub. Date: Aug. 18, 2005

(54) Display control apparatus and method, recording medium, and program

(76) Inventor: Kazuki Yokoyama, Kanagawa (JP)

Correspondence Address: William S. Frommer, Esq.;FROMMER LAWRENCE & HAUG LLP, 745 Fifth Avenue, New York, NY, 10151, US

(21) Appl. No.: 11/039,265

(22) Filed: Jan. 20, 2005

(30) Foreign Application Priority Data
Jan. 21, 2004 (JP) 2004-012577

(51) Int. Cl. G03B 17/00

(52) U.S. Cl. 396/421

(57) ABSTRACT

A display control apparatus of the present invention includes a detection section for detecting a user view point on a screen of a display apparatus, and a control section for controlling image display in order to suppress components in spatial frequencies of an image detected by the detection section around the user view point.

### CROSS REFERENCE TO RELATED APPLICATION

This application claims priority from Japanese Priority Document No. 2004-012577, filed on Jan. 21, 2004 with the Japanese Patent Office, which document is hereby incorporated by reference.

### BACKGROUND OF THE INVENTION

1. Field of the Invention

The present invention relates to a display control apparatus and method, a recording medium, and a program, and more particularly to a display control apparatus and method, a recording medium, and a program, each capable of controlling the visibility of an image.

2. Description of Related Art

Recently, a portable information processing apparatus specifying users and being operated in public places, such as a cellular phone, a personal digital assistant (PDA), an electronic paper, and the like has become widespread.

Moreover, a head mounted display has been proposed, wherein the head mounted display detects the direction of an observation object and a position of the observation object which the user is now watching by detecting the direction of the visual line of the user (e.g. Patent Document 1).

Moreover, another image processing system has been proposed in which, the image processing system controls the display of an image picked up by a camera worn on a human body, corrects the jiggling of the image of an object shot by the person in accordance with the movement of the person, or performs a scene change (e.g. Patent Document 2).

Patent Document 1: Japanese Patent Laid-Open Publication No. 2001-34408

Patent Document 2: Japanese Patent Laid-Open Publication No. 2003-19886

### SUMMARY OF THE INVENTION

However, these portable information processing apparatuses have a problem in which, when the visibility of a display apparatus is improved, displayed contents are easily looked into by a third person other than a user, and when the view angle of the display apparatus is conversely narrowed for preventing the contents of an image from being easily looked into by a third person, the visibility of the display apparatus is lowered to make the user difficult to recognize the displayed contents.

Moreover, the inventions described in the Patent Document 1 and Patent Document 2 do not disclose the control of the visibility of the displayed image, and the problem has not been solved.

Accordingly, the present invention was made in consideration of such a situation, and makes it possible to control the visibility of an image on the basis of the user view point.

A display control apparatus of the present invention includes a detection section for detecting a user view point on a screen of a display apparatus, and a control section for controlling an image display in order to suppress components in spatial frequencies of an image around the user view point detected by the detection section.

The control section can control the image display in order to suppress the components in the high spatial frequencies of a pixel of the image on the basis of a distance between the pixel and the user view point.

The display control apparatus can further include filters for removing the components in the high spatial frequencies of the pixel of the image, and the control section can control the image display in order to suppress the components in the spatial frequencies of the image around the user view point by selecting an output among the outputs of the filters.

The display control apparatus can further include an obtaining section for acquiring image data obtained by imaging the user, and the detection section can detect the user view point on the basis of the image data acquired by the obtaining section.

A display control method of the present invention includes a detection step of detecting a user view point on a screen of a display apparatus, and a control step of controlling an image display in order to suppress components in spatial frequencies of an image around the user view point detected by the processing of the detection step.

A program recorded on a recording medium of the present invention includes a detection step of detecting a user view point on a screen of a display apparatus, and a control step of controlling an image display in order to suppress components in spatial frequencies of an image around the user view point detected by the processing of the detection step.

A program of the present invention includes a detection step of detecting a user view point on a screen of a display apparatus, and a control step of controlling an image display in order to suppress components in spatial frequencies of an image around the user view point detected by the processing of the detection step.

In the display control apparatus, the display control method, the program recorded on the recording medium, and the program of the present invention, the user view point on the screen of the display apparatus is detected, and the image display is controlled in order to suppress the components of the spatial frequencies of the image around the detected user view point.

As described above, according to the present invention, the visibility of the displaying image can be controlled. Moreover, according to the invention, it is possible to make it difficult for a third person other than a user to look into the displayed contents easily while the user can surely recognize the displayed contents.

### BRIEF DESCRIPTION OF THE DRAWINGS

FIG. 1 is a view showing an example of the configuration of an image display system to which the present invention is applied;

FIG. 2 is a view showing an example of an image input into the image display system;

FIG. 3 is a view showing an position of a view point on the screen of a display apparatus;

FIG. 4 is a view showing an example of the screen to be displayed on the display apparatus;

FIG. 5 is a view illustrating the coordinate system of the display apparatus;

FIG. 6 is a view showing an example of the configuration of a display control unit;

FIG. 7 is a view showing an example of the frequency characteristic of a filter;

FIG. 8 is a view showing an example of the frequency characteristic of a filter;

FIG. 9 is a view showing an example of the frequency characteristic of a filter;

FIG. 10 is a view showing an example of the frequency characteristic of a filter;

FIG. 11 is a flowchart illustrating view point detection processing in an image display system;

FIG. 12 is a flowchart illustrating the image display processing in the image display system;

FIG. 13 is a view showing an example of the division of an area of the screen of the display apparatus;

FIG. 14 is a view showing an example of the frequency characteristic of image data;

FIG. 15 is a view showing a position of the view point on the screen of the display apparatus;

FIG. 16 is a view showing an example of the screen to be displayed on the display apparatus;

FIG. 17 is a flowchart illustrating image display processing in the image display system; and

FIG. 18 is a block diagram showing an example of the configuration of a personal computer.

### DESCRIPTION OF THE PREFERRED EMBODIMENTS

In the following, an embodiment of the present invention will be described. The corresponding relations between the invention and the embodiment, each described in the present specification, are exemplified as follows. Regarding the description, even if an embodiment which is described in the present specification but is not described as one corresponding to the invention exists, the description does not mean that the embodiment does not correspond to the invention. Conversely, even if an embodiment is described as one corresponding to an invention, the description does not mean that the embodiment does not correspond to the inventions other than the former invention.

Furthermore, the description does not mean that all of the inventions described in the present specification are claimed. In other words, the description does not deny the existence of the inventions which are described in the present specification and are not claimed in the present application, i.e. the existence of the inventions which will be filed as a divisional application, or will appear by correction, or will be added to the present claims in the future.

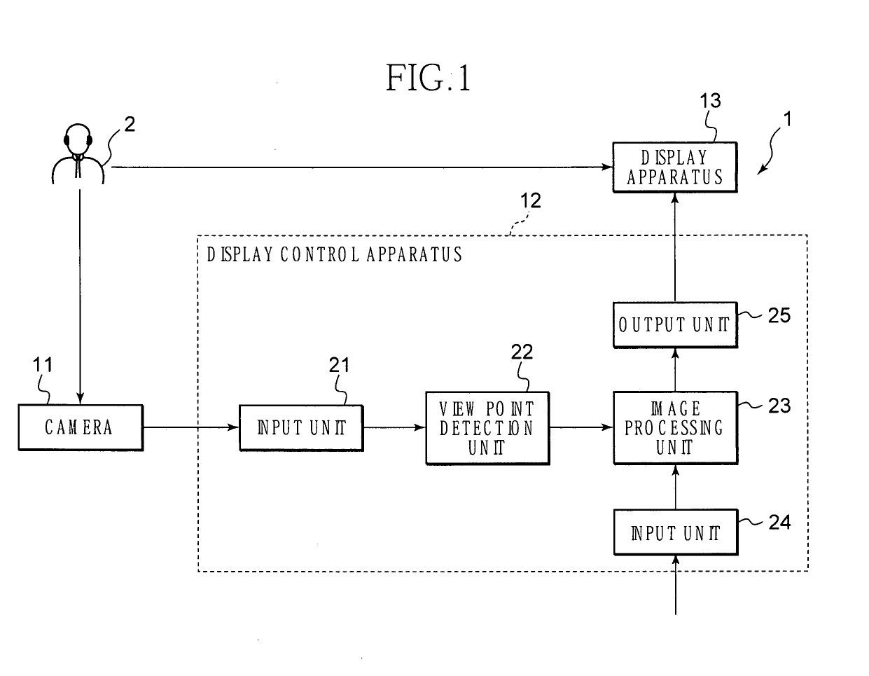

According to the present invention, a display control apparatus is provided. The display control apparatus (e.g. a display control apparatus 12 of FIG. 1) includes a detection section (e.g. a view point detection unit 22 of FIG. 1) for detecting the user view point on the screen of a display apparatus (e.g. a display apparatus 13 of FIG. 1), and a control section (e.g. an image processing unit 23 of FIG. 1) for controlling an image display in order to suppress the components in the spatial frequencies of an image around the user view point detected by the detection section.

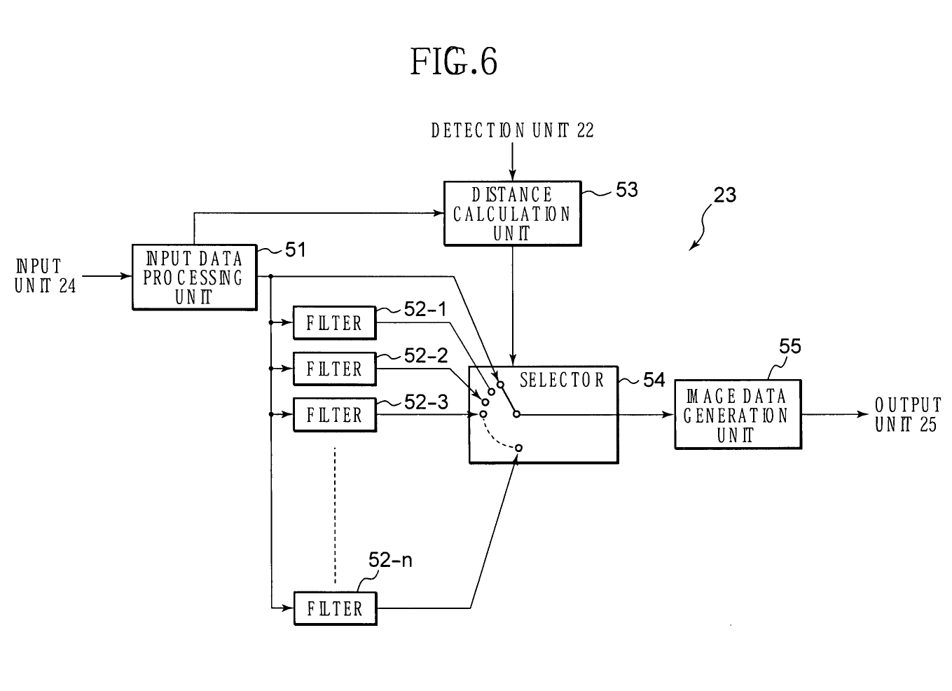

The display control apparatus (e.g. the display control apparatus 12 of FIG. 1) further includes filters (e.g. filters 52-1 to 52-n of FIG. 6) for removing the components of the high spatial frequencies of a pixel of the image, and the control section can control the image display in order to suppress the components of the spatial frequencies of the image around the user view point by selecting an output among the outputs of the filters.

The display control apparatus (e.g. the display control apparatus 12 of FIG. 1) further includes an obtaining section (e.g. an input unit 21 of FIG. 1) for obtaining image data (e.g. user image data) acquired by shooting the user, and the detection section can detect the user view point on the basis of the image data obtained by the obtaining section.

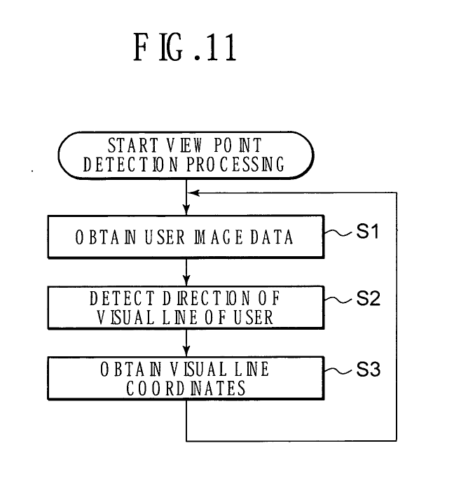

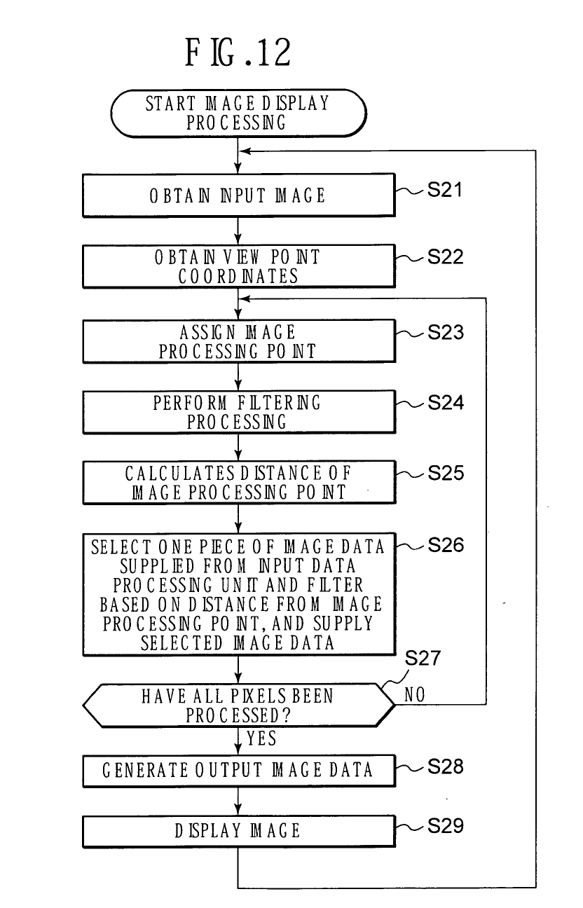

According to the present invention, a display control method is provided. The display control method includes a detection step (e.g. Step S3 in FIG. 11) of detecting a user viewpoint on a screen of a display apparatus (e.g. the display apparatus 13 in FIG. 1), and a control step (e.g. Steps S23 to S27 in FIG. 12) of controlling an image display in order to suppress components in spatial frequencies of an image around the user view point detected by the processing of the detection step.

According to the present invention, a program is provided. The program includes a detection step (e.g. Step S3 in FIG. 11) of detecting a user view point on a screen of a display apparatus (e.g. the display apparatus 13 in FIG. 1), and a control step (e.g. Steps S23-S27 in FIG. 12) of controlling an image display in order to suppress components in spatial frequencies of an image around the user view point detected by the processing of the detection step.

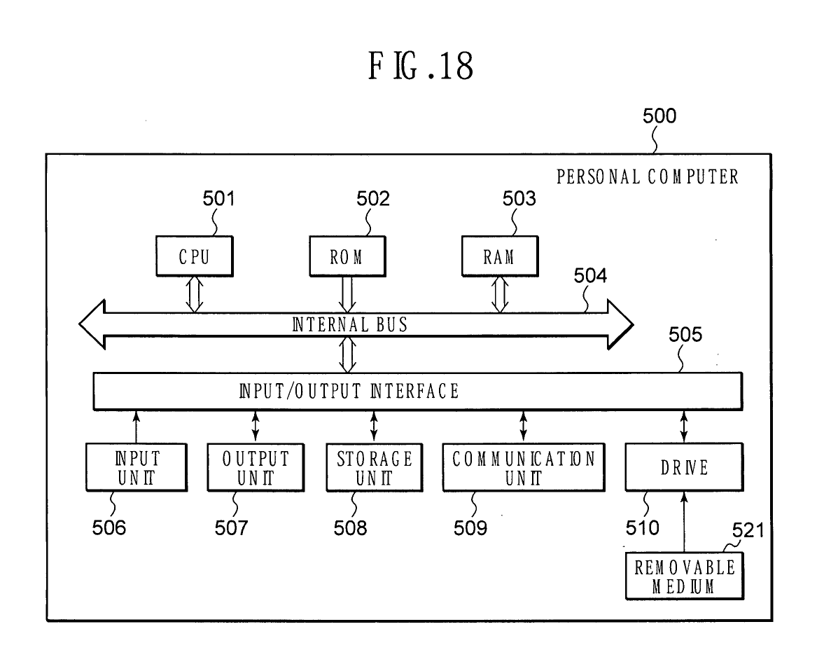

The program can be recorded in a recording medium (e.g. a removable medium 521 in FIG. 18).

Hereinafter, referring to the attached drawings, an embodiment of the present invention is described.

FIG. 1 is a block diagram showing an example of the basic configuration of an image display system 1 to which the present invention is applied. The image display system 1 is composed of a camera 11, the display control apparatus 12, and the display apparatus 13.

The camera 11 is provided near to the display apparatus 13, and always shoots a user 2 using the image display system 1 to output imaged data (hereinafter referred to as user image data) to the display control apparatus 12.

The display control apparatus 12 detects a position on a screen of the display apparatus 13 where the user 2 watches, i.e. the user view point on the basis of the user image data obtained from the camera 11. The display control apparatus 12 generates image data the visibility of which is controlled (hereinafter referred to as output image data) from the input image data (hereinafter referred to as input image data) on the basis of the detected the view point of the user 2, and outputs the generated output image data to the display apparatus 13.

A human being has visual sense characteristics such that the human being can recognize an image to its fine changes at a position near to a visual line as the center (central visual field), but that the human being cannot recognize fine changes of the image at a position as the position becomes distant from the visual line. That is to say, the spatial frequency band which the human being can recognize is the widest at the central visual field, and the high frequency components of the spatial frequency band at a position lowers as the position becomes distant from the visual line. Consequently, the spatial frequency band becomes narrower as the position becomes distant from the visual line.

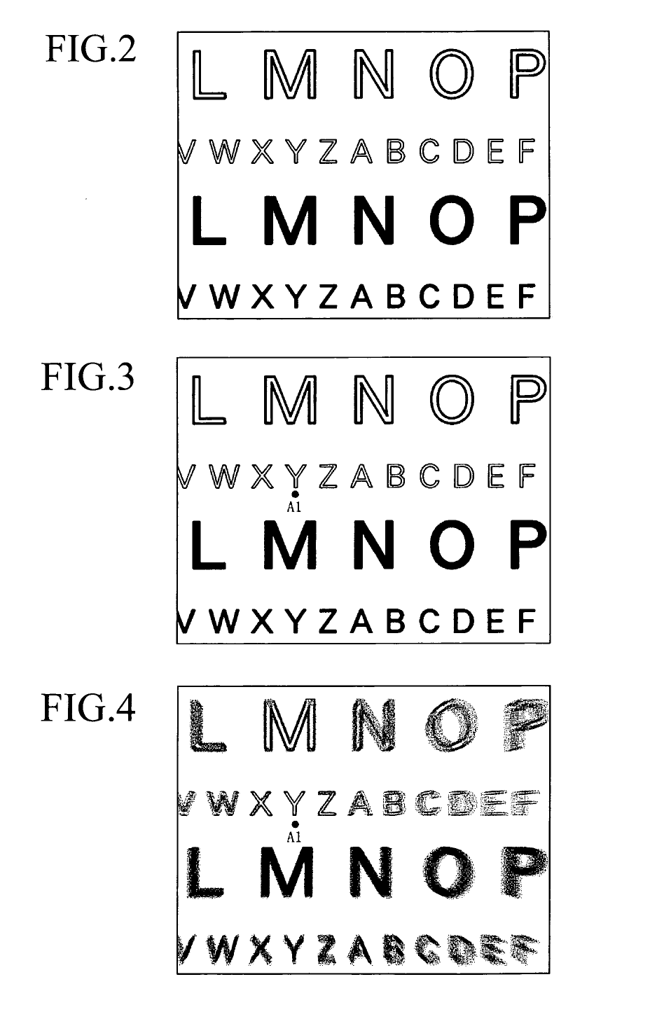

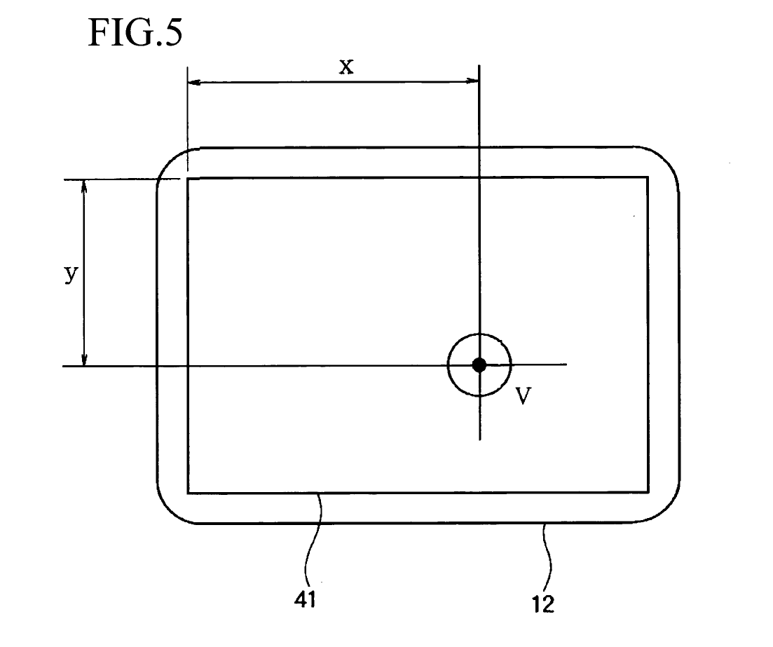

For example, in the case where an image shown in FIG. 2 is input into the display control apparatus 12 and the image is displayed on the display apparatus 13, when the center of the user view point is turned to a point A1 in FIG. 3, the display control apparatus 12 performs the control utilizing the visual sense characteristics of the human being in order to display an image in which the spatial frequency components of the image near to the point A1 are left as they are, and in which the high spatial frequency components of the image becomes more suppressed as a position of the image becomes more distant from the point A1, as shown in FIG. 4. That is to say, in the image displayed on the display apparatus 13, the parts of the image near to the center of the user view point are displayed as they are, and the fine changes of the image the differentiation of which becomes more difficult for the user 2 as the changes becomes more distant from the center of the user view point are removed from the image.

The display apparatus 13 displays an image on the basis of the output image data obtained from the display control apparatus 12.

The display control apparatus 12 is composed of the input unit 21, the view point detection unit 22, the image processing unit 23, an input unit 24 and an output unit 25.

The view point detection unit 22 obtains the coordinates of the center of a view point V of the user 2 (hereinafter referred to as view point coordinates) on a screen 41 of the display apparatus 13 as shown in FIG. 5 on the basis of the user image data obtained from the camera 11 through the input unit 21, which will be described later by referring to FIG. 11. The coordinate system of the screen 41 is expressed by taking the upper left corner of the screen 41 as the origin, and by taking the horizontal right direction as the x-axis direction, and further by taking the vertical downward direction as the y-axis direction. The view point detection unit 22 transmits the detected view point coordinates to the image processing unit 23.

The image processing unit 23 obtains input image data through the input unit 24. The image processing unit 23 outputs the output image data obtained by controlling the spatial frequency components of the input image data on the basis of the view point coordinates transmitted from the view point detection unit 22, which will be described later by referring to FIG. 12, to the display apparatus 13 through the output unit 25.

FIG. 6 is a block diagram showing an example of the basic configuration of the image processing unit 23. The image processing unit 23 is composed of an input data processing unit 51, the filters 52-1 to 52-n (hereinafter referred to as a filter 52 simply when it is needless to express the filters 52-1 to 52-n in distinction from each other), a distance calculation unit 53, a selector 54 and an image data generation unit 55.

The input data processing unit 51 obtains input image data through the input unit 24. The input data processing unit 51 assigns each pixel in the input image data to an image processing point which is made to be an object of the filtering of the spatial frequency components in order. The input data processing unit 51 supplies the image data of the pixel assigned to the image processing point to the selector 54, and supplies the image data of the pixel in a predetermined area around the image processing point as the center to the filter 52. The input data processing unit 51 transmits the coordinates of the assigned image processing point on the screen 41 to the distance calculation unit 53.

The filter 52 suppresses the spatial frequency components of the spatial frequency equal to or more than a predetermined cut-off frequency of the image data of the image processing point obtained from the input data processing unit 51, and supplies the suppressed spatial frequency components to the selector 54.

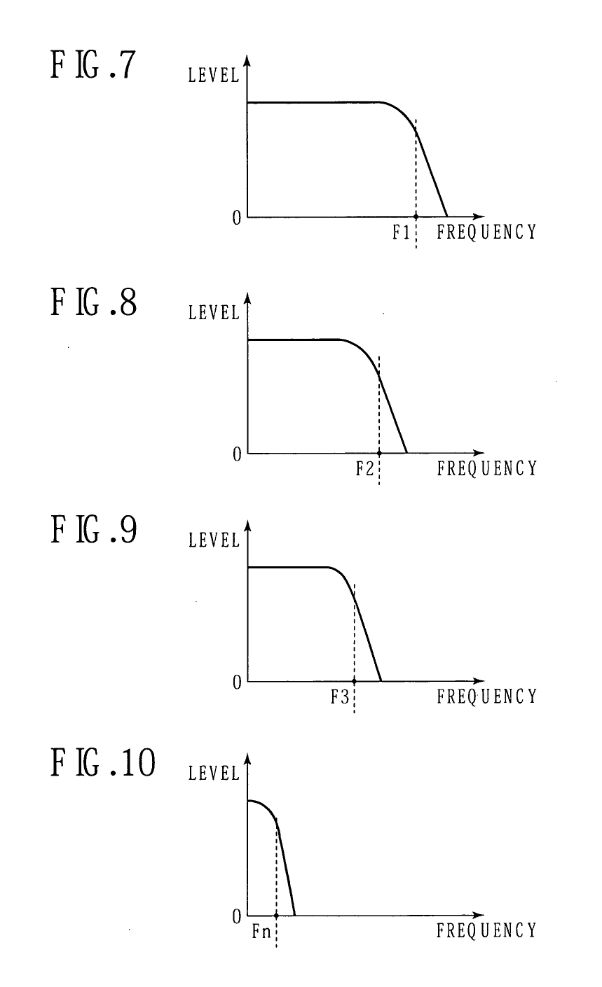

The filter 52 is a filter having a cut-off frequency different from each other. In the following, descriptions are given on the supposition that the frequency characteristic of the filter 52-1 is shown in a graph of FIG. 7, the frequency characteristic of the filter 52-2 is shown in a graph of FIG. 8, the frequency characteristic of the filter 52-3 is shown in a graph of FIG. 9, and the frequency characteristic of the filter 52-n is shown in a graph of FIG. 10. As shown in FIGS. 7-10, the cut-off frequencies F1, F2 and F3 of the filters 52-1, 52-2 and 52-3 lower in the order, and the cut-off frequency Fn of the filter 52-n is the lowest among the whole filter 52.

As shown in the frequency characteristics of FIGS. 7-10, the spatial frequency components are attenuated by the filter 52 from a frequency a little lower than the cut-off frequency of the image data, and almost all of the spatial frequency components at frequencies higher than the cut-off frequency are removed from the image data.

For example, the filter 52 is made to be a spatial filter, and outputs the data obtained by multiplying the image data of each pixel within a predetermined area around the image processing point as the center (a filter size) by a predetermined coefficient, and by adding the multiplied image data with each other (by performing the convolution integral of the image data), as the image data at the image processing point. Thereby, the spatial frequency components of the frequencies equal to or more than the cut-off frequency which spatial frequency components are included in the image data at the image processing point are suppressed. The cut-off frequency of the spatial filter is adjusted according to the magnitude of the filter size, i.e. the magnitude of the area of the object of the convolution integral (the number of the pixels of the objects of the convolution integral) and the coefficient.

The distance calculation unit 53 obtains view point coordinates from the detection unit 22, and obtains the coordinates at the image processing point from the input data processing unit 51. Then, distance calculation unit 53 obtains the distance between the image processing point and the view point coordinates (hereinafter referred to as a distance from an image processing point) to transmit the obtained distance from the image processing point to the selector 54.

The selector 54 selects one piece of image data between the image data directly supplied from the input data processing unit 51 and the image data the high spatial frequency components of which are suppressed (or removed) by the filter 52 on the basis of the distance from the image processing point transmitted from the distance calculation unit 53, and supplies the selected image data to the image data generation unit 55.

The image data generation unit 55 generates output image data for one frame from the image data of each pixel supplied from the selector 54, and outputs the generated image data to the display apparatus 13 through the output unit 25.

Next, referring to FIGS. 11-16, the processing executed by the image display system 1 is described.

First, referring to the flowchart of FIG. 11, the view point detection processing executed by the image display system 1 is described. Incidentally, the processing is started when the user 2 commands the start of the processing, and is stopped when the user 2 commanded the stop of the processing.

At Step S, the view point detection unit 22 obtains user image data imaged by the camera 11 through the input unit 21.

At Step S2, the view point detection unit 22 detects the direction of a visual line of the user 2 on the basis of the user image data. For example, the view point detection unit 22 detects the contours of the both eyes of the user 2, the positions of the both ends of the both eyes, and the positions of the nostrils on the basis of the user image data. The view point detection unit 22 estimates the center positions and the radii of the eyeballs on the basis of the positions of the both ends of the both eyes and the positions of the nostrils, and detects the center positions of the pupils on the basis of the brightness information in the contours of the eyes of user 2. The view point detection unit 22 operates vectors connecting the centers of the eyeballs and the centers of the pupils, and sets the directions of the obtained vectors as the directions of the visual lines of the user 2.

At Step S3, the view point detection unit 22 detects the view point on the screen 41 of the display apparatus 13 which view point the user 2 is watching on the basis of the directions of the visual lines of the user 2 detected by the processing at Step S2. The view point detection unit 22 sets the coordinates of the pixel located at the center of the detected view points as the view point coordinates. After that, the processing returns to Step S1, and the processing of Steps S1 to S3 is repeated.

Next, referring to the flowchart of FIG. 12, the image display processing executed by the image display system 1 is described. Incidentally, the processing is started when the user 2 commands the start of the processing, and ends when the user 2 commands the stop of the processing.

At Step S21, the input data processing unit 51 obtains input image data through the input unit 24. In the following, descriptions are given on the supposition that the input image data of the image shown in FIG. 2 is obtained at Step S21.

At Step S22, the distance calculation unit 53 obtains the view point coordinates obtained by the processing at Step S3 of FIG. 11 from the view point detection unit 22. In the following, descriptions are given on the supposition that the coordinates of the point A1 shown in FIG. 3 is obtained at Step S22 as the view point coordinates.

At Step S23, the input data processing unit 51 assigns one pixel in the input image data as an image processing point. For example, the pixels of the image processing points are assigned with the order of a raster scan.

At Step S24, filtering processing is performed to the image data at the image processing point. To put it concretely, the input data processing unit 51 supplies the image data in a predetermined area around the image processing point as the center to the filter 52. The filter 52 suppresses the spatial frequency components of the frequencies equal to or more than the cut-off frequency which spatial frequency components are included in the image data of the image processing point, and supplies the suppressed image data to the selector 54. Moreover, the input data processing unit 51 supplies the image data at the image processing point, i.e. the image data having the spatial frequency components receiving no processing as the original input image data, to the selector 54 directly. Consequently, n+1 kinds of image data composed of the image data having the spatial frequency components as the original input image data, and the image data having the spatial frequency components including the suppressed parts at frequencies equal to or more than any one of the cut-off frequencies F1 to Fn which have been suppressed by the filters 52-1 to 52-n are supplied to the selector 54 as the image data at the image processing point.

At Step S25, the distance calculation unit 53 obtains the coordinates at the image processing point from the input data processing unit 51 and calculates a distance z from an image processing point to transmit the calculated distance Z to the selector 54. When it is supposed that the coordinates of the point A1 being the view point coordinates are (vx, vy) and the coordinates of the image processing point is (x, y), the distance z from the image processing point can be obtained in accordance with the following formula (1).
Z=\sqrt{(x−vx)²+(y−vy)²} (1)

At Step S26, the selector 54 selects one piece of the image data between the image data supplied from the input data processing unit 51 and the image data supplied from the filters 52-1 to 52-n at Step S24 on the basis of the distance z from the image processing point transmitted from the distance calculation unit 53, and supplies the selected image data to the image data generation unit 55 as the image data at the image processing point.

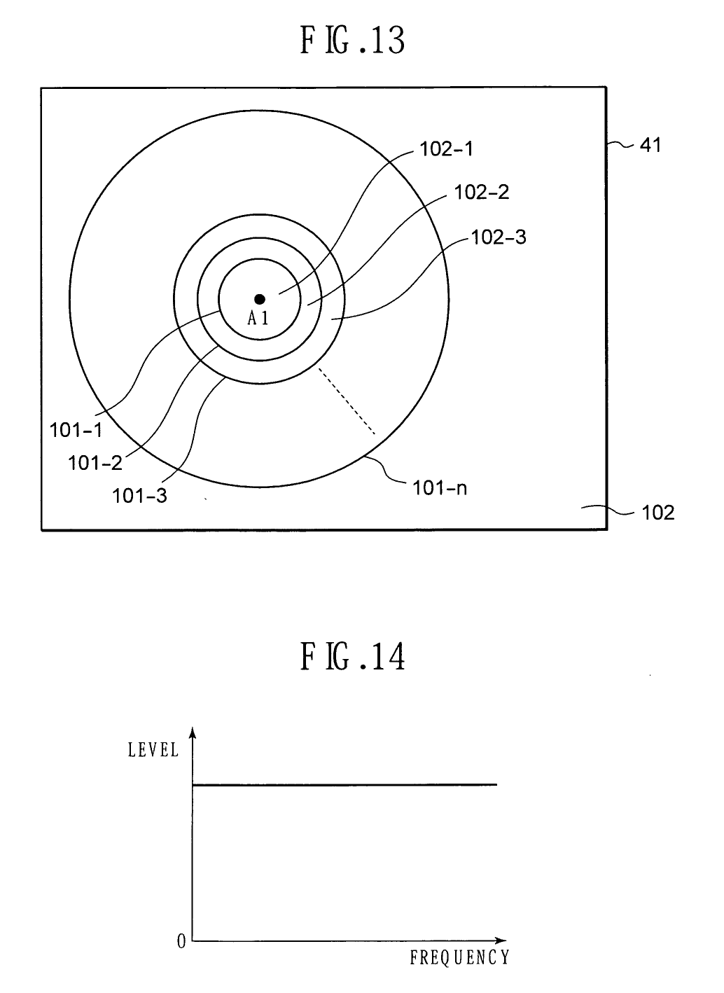

For example, as shown in FIG. 13, the selector 54 divides the screen 41 into n+1 areas of areas 102-1 to 102-n+1 by concentric circles 101-1 to 101-n, which have the center of the point A1 (view point coordinates) being the center of the user view point 2 and have radii different from each other. When the radii of the concentric circles 101-1 to 101-n are denoted as radii z1 to zn, respectively, the relation of the magnitudes of the radii z1 to zn is expressed as the following formula (2).
0<z1<z2<z3< . . . <zn (2)

The screen 41 is divided into the areas such that an area in the inside of the concentric circle 101-1 is the area 102-1, an area between the concentric circle 101-1 and the concentric circle 101-2 is the area 102-2, and an area between the concentric circle 101-2 and the concentric circle 101-3 is the area 102-3, and the area on the outside of the concentric circle 101-n are supposed to be the area 102-n+1.

In case of 0≦z<z1, i.e. in the case where the image processing point is included in the area 102-1, the selector 54 supplies the image data supplied directly from the input data processing unit 51 to the image data generation unit 55 on the basis of the distance z from the image processing point. That is to say, the space frequency components of the image data of the pixels included in the area 102-1 including the point A1 being the view point coordinates are not altered as shown by the frequency characteristic of FIG. 14.

In case of z1≦z<z2, i.e. in the case where the image processing point is included in the area 102-2, the selector 54 supplies the image data supplied from the filter 52-1 to the image data generation unit 55. In case of z2-≦z<z3, i.e. in the case where the image processing point is included in the area 102-3, the selector 54 supplies the image data supplied from the filter 52-2 to the image data generation unit 55. After that, the selector 54 similarly selects the image data to be supplied to the image data generation unit 55 on the basis of the distance z from the image processing point, and supplies the selected data to the image data generation portion 55. In case of z≧zn, i.e. in the case where the image processing point is included in the area 102-n+1, the selector 54 supplies the image data supplied from the filter 52-n to the image data generation unit 55.

That is to say, as a pixel becomes farther from the point A1 being the view point coordinates, the high spatial frequency components of the image data become suppressed by means of a lower cut-off frequency on the basis of the frequency characteristic of each filter 52 as shown in FIGS. 7-1.

Incidentally, in the case where no view point coordinates can be obtained at Step S22, the selector 54 supplies the image data supplied from the filter 52-n to the image data generation portion 55 at Step S26. Thereby, when the user 2 does not look at the screen 41, the spatial frequency components of the image data which are higher than the lowest cut-off frequency Fn to the whole image are suppressed.

Moreover, when no view point coordinates can be obtained at Step S22, the selector 54 may supply the image data supplied from the input data processing unit 51 without passing through the filter 52 to the image data generation unit 55 at Step S26. In this case, the input image is displayed on the display apparatus 13 as it is.

At Step S27, the input data processing unit 51 judges whether or not all of the pixels in the input image data have been processed. In the case where it is judged that not all of the pixels in the input image data have been processed, the processing returns to Step S23. The processing at Step S23 to S27 is repeated until it is judged at Step S27 that all of the pixels in the input image data have been processed. That is to say, the spatial frequency components of all of the pixels in the input image data are suppressed according to the distance between the point A1 being the center of the user view point 2 and each pixel.

In the case where it is judged that all of the pixels have been processed at Step S27, the processing proceeds to Step S28. At Step S28, the image data generation unit 55 generates output image data for one frame from the image data of all of the pixels supplied from the selector 54.

At Step S29, the image data generation unit 55 outputs the output image data to the display apparatus 13 through the output unit 25. The display apparatus 13 displays an image based on the output image data. That is to say, as shown in FIG. 4, the visibility of the image near to the point A1 being the center of the user view point is let to be the input image as it is, and the image having the more reduced visibility is displayed in an area the distance of which is more distant from the point A1 to make it difficult for the user 2 to differentiate fine changes of the image.

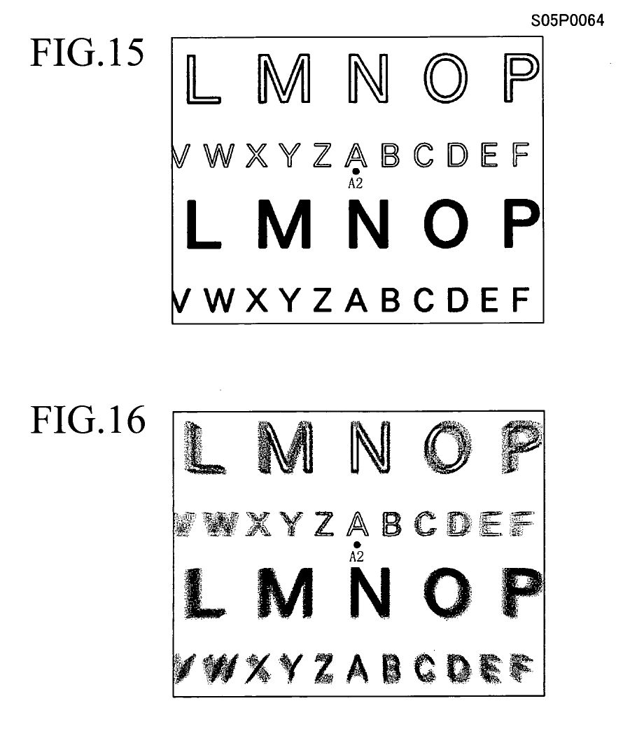

After that, the processing returns to Step S21, and the processing from Step S21 to Step S29 is repeated, and the spatial frequency components of the image to be displayed on the display apparatus 13 is controlled according to the movement of the user view point 2. For example, in the case where the center of the user view point 2 has been moved from the point A1 of FIG. 4 to point A2 of FIG. 15, the high spatial frequency of the image is suppressed around the point A2 as the center as shown in FIG. 16, and thus the visibility of the image is controlled.

In the way described above, the image obtained by suppressing the high spatial frequency components of an input image according to the user view point 2 is displayed, and thereby the visibility of the image to a third person other than the user 2 can be lowered without lowering the visibility of the image to the user 2. Consequently, it is possible to make the third person other than the user 2 impossible to look the contents of the image easily. That is to say, the user 2 can naturally look or distinguish the contents of the displayed image. On the other hand, to the third person having the different the view point from that of the user 2, the image becomes one having deteriorated sharpness except for the area near to the center of the user view point 2 where the high spatial frequency components of the image are not suppressed, and the third person other than the user 2 becomes not able to recognize the contents of the image.

Moreover, the high spatial frequency components included in an image are suppressed, and thereby no images having high sharpness are displayed except for the area near to the center of the user view point 2. In addition, the displayed image changes as the user view point 2 moves. Thereby, an aged deterioration owing to the generation of the burning of the screen 41 of the display apparatus 13 made of a display apparatus having fixed pixels such as a plasma display panel (PDP) or the like can be relieved.

In the case where the user view point on the screen of a display apparatus is detected in such a way and the visibility of a displayed image is controlled according to the detected user view point, it is possible to make a third person impossible to look displayed contents easily while the user can surely recognize the displayed contents.

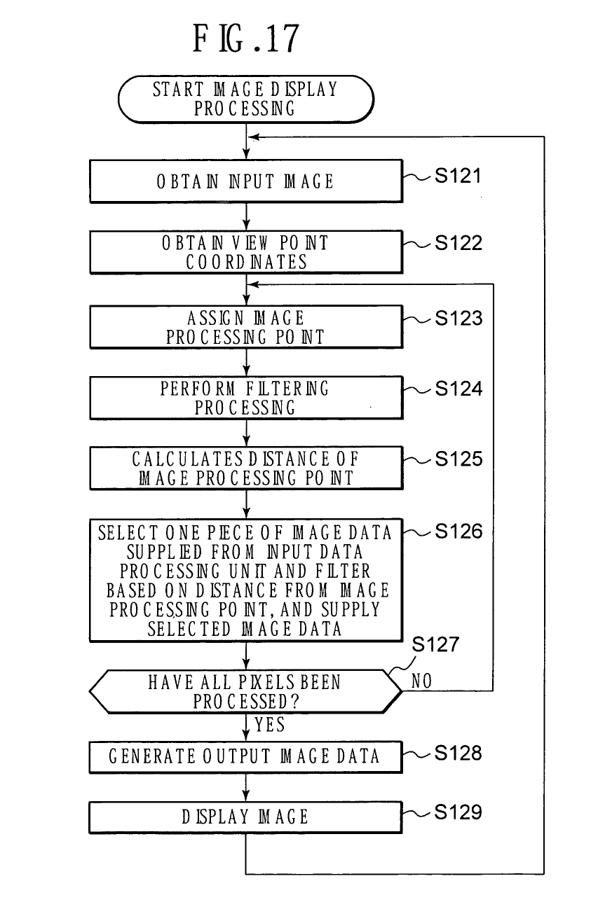

Incidentally, in the above-mentioned embodiment of the image display system 1, to which the present invention is applied, an example in which a view point coordinates is obtained every processing of image data for one frame and the image display processing of the image data for one frame is performed with the view point coordinates being fixed is shown. However, it is also possible to alter the view point coordinates always in accordance with the direction of the visual line of the user without fixing the view point coordinates even in the same frame while executing image display processing. In the following, referring to the flowchart of FIG. 17, the image display processing in case of altering the view point coordinates always is described.

As it is apparent by comparing the flowcharts of FIGS. 12 and 17, the basic processing of the image display processing in the case of fixing the view point coordinates during the processing of the image data for one frame (FIG. 12) and the basic processing in the case of altering the view point coordinates during the processing of the image data for one frame (FIG. 17) are similar to each other.

However, in the case where the view point coordinates is altered, differently from the case where the view point coordinates is fixed, when it is judged that not all of the pixels in the input image data have been processed at the processing at Step S127 corresponding to Step S27 of FIG. 12, the processing does not return to Step S123 corresponding to Step S23, but returns to Step S122 corresponding to Step S22, and the processing from Step S122 to S127 is repeated until it is judged that all pixels in the input image data have been processed at Step S127. That is to say, a pair of view point coordinates is obtained every completion of processing of one pixel in input image data, and the high spatial frequency components of the image data of the pixel assigned to the image processing point are suppressed according to the obtained view point coordinates.

Thereby, the spatial frequency components of an image displayed on the display apparatus 13 are controlled on the basis of the moves of the user view point 2 more strictly.

Moreover, as the method of detecting the direction of the visual line of a user, a technique of irradiating a user with an infrared ray to perform the detection using an infrared ray image, or various face image recognition technologies may be used.

Moreover, the high spatial frequency components may be suppressed by the following procedure. That is to say, the areas obtained by dividing input image data at every predetermined size (for example, 8×8 pixels) are assigned as image processing points, and the image data in each of the areas is deconstructed into spatial frequency components by performing the orthogonal transformation thereof such as discrete cosine transform (DCT) to be supplied to the filter 52.

Incidentally, the present invention can be applied to an portable information processing apparatus such as electronic paper, a cellular phone, a personal digital assistant (PDA).

The above-mentioned series of processing may be executed by hardware or by software. In the case where the series of processing is executed by software, the programs constituting the software are installed through a network or a recording medium into a computer incorporated in dedicated hardware, or in, for example, a general-purpose personal computer capable of executing various functions with various programs installed therein.

FIG. 18 is a view showing an example of the configuration of the inside of a general-purpose personal computer 500. A central processing unit (CPU) 501 executes various kinds of processing in accordance with a program stored in a read only memory (ROM) 502, or a program loaded on a random access memory (RAM) from a storage unit 508. Also the data necessary for the CPU 501 to execute various kinds of processing is suitably stored in the RAM 503.

The CPU 501, the ROM 502 and the RAM 503 are connected with each other through a bus 504. Also an input/output interface 505 is connected to the bus 504.

An input unit 506 composed of buttons, switches, a keyboard and a mouse, an output unit 507 composed of a display such as a cathode ray tube (CRT) or a liquid crystal display (LCD) and a speaker, a storage unit 508 composed of a hard disk or the like, and a communication unit 509 composed of a modem or a terminal adapter are connected to the input/output interface 505. The communication unit 509 performs communication processing through a network including the Internet.

A drive 510 is also connected to the input/output interface 505 as occasion demands. A removable medium 511 such as a magnetic disk, an optical disk, a magneto-optical disk or a semiconductor memory is suitably mounted on the drive 510. A computer program read from the removable medium 511 is installed into the storage unit 508.

The recording medium for recording a program is installed in a computer and is made to be executable by the computer. As shown in FIG. 18, the recording medium is not only composed of a removable medium 511 such as a magnetic disk (including a flexible disk), an optical disk (including a compact disc-read only memory (CD-ROM) and a digital versatile disc (DVD)), the magneto-optical disk (mini-disc (MD): registered trademark) or a semiconductor memory, each being delivered for supplying a program to a user separately from the main body of an apparatus and having a recorded program, but also is composed of the ROM 503 or the hard disk included in the storage unit 508, each being supplied to the user in the state of being incorporated in the main body of the apparatus in advance and having a recorded program.

Incidentally, the step of describing a program stored in the program storage medium in the present specification includes the processing executed in time series along the described order, of course, and also includes the processing executed in parallel or independently, though it is not necessary processed in time series.

Moreover, in the present specification, the term of system indicates the whole apparatus composed of a plurality of apparatus.

1. A display control apparatus for controlling an image display on a display apparatus comprising:
a detection section for detecting a user view point on a screen of the display apparatus; and
a control section for controlling the image display in order to suppress components in spatial frequencies of an image detected by the detection section around the user view point.

2. The display control apparatus as cited in claim 1, wherein
said control section is able to control the image display in order to suppress the components in the high spatial frequencies of a pixel of the image on the basis of a distance between the pixel and the user view point.

3. The display control apparatus as cited in claim 2, further comprising:
filters for removing the components in the high spatial frequencies of the pixel of the image, wherein
said control section is able to control the image display in order to suppress the components in the spatial frequencies of the image around the user view point by selecting an output among the outputs of the filters.

4. The display control apparatus as cited in claim 1, wherein
the larger the distance between the pixel and the user view point is, the more the components in the high spatial frequencies of the pixel of the image is suppressed.

5. The display control apparatus as cited in claim 2, wherein
the larger the distance between the pixel and the user view point is, the more the components in the high spatial frequencies of the pixel of the image is suppressed.

6. The display control apparatus as cited in claim 1, further comprising:
an obtaining section for acquiring image data obtained by imaging the user, wherein
said detection section detects the user view point on the basis of the image data acquired by the obtaining section.

7. A display control method for controlling an image display on a display apparatus comprising:
a detection step of detecting a user view point on a screen of the display apparatus; and
a control step of controlling the image display in order to suppress components in spatial frequencies of an image around the user view point detected by the processing of the detection step.

8. A program recorded on a recording medium in a computer-readable form for executing an image display control which controls the image display on a display apparatus, comprising:
a detection step of detecting a user view point on a screen of the display apparatus; and
a control step of controlling the image display in order to suppress components in spatial frequencies of an image around the user view point detected by the processing of the detection step.

9. A program to be executed by a computer for executing an image display control which controls the image display on a display apparatus, comprising:
a detection step of detecting a user view point on a screen of the display apparatus; and
a control step of controlling the image display in order to suppress components in spatial frequencies of an image around the user view point detected by the processing of the detection step.
